(19) United States
(12) Patent Application Publication
(10) Pub. No.: US 2015/0366319 A1
(43) Pub. Date: Dec. 24, 2015

(54) PERFUME BOTTLE

(71) Applicants: Rony AKRISH, Binyamina (IL); Ron HOROWITZ, Givat Shmuel (IL)

(72) Inventors: Rony Akrish, Binyamina (IL); Ron Horowitz, Givat Shmuel (IL)

(21) Appl. No.: 14/410,402

(22) PCT Filed: Jun. 20, 2013
(86) PCT No.: PCT/IL2013/050529

§ 371 Date: Dec. 22, 2014

Related U.S. Application Data
(60) Provisional application No. 61/662,381, filed on Jun. 21, 2012.

(51) Int. Cl. A45D 34/04; B05B 11/00; B05B 15/00; B65D 25/04; B65D 25/40

(52) U.S. Cl. CPC A45D 34/04; B65D 25/04; B65D 25/40; B05B 15/005; B05B 11/3023; A45D 2034/007

(57) ABSTRACT

The present invention provides a perfume spray bottle (100) comprising a receptacle (102) having side walls (104) and an inner bottom surface (106) for accommodating liquids, wherein a minor portion of the bottom surface comprises a lower gathering region (108), the bottle further comprising a pump (110) for drawing the liquid up a suction tube (112) and through a nozzle (114), wherein at least the end of the suction tube is disposed within the lower gathering region.

### FIELD OF THE INVENTION

The present invention relates to the field of spray bottles. More particularly, the present invention relates to perfume spray bottles. Even more particularly the present invention relates to perfume spray bottles having a unique internal design that enables more effective usage.

### BACKGROUND OF THE INVENTION

Prior art spray bottles generally comprise a receptacle and a pump. The receptacle accommodates liquids therein and the pump draws liquid from the bottom of the receptacle up a suction tube, and sprays the liquid through an atomizer nozzle.

In some bottles the pump may be positioned in the center of the top of the receptacle such that the suction tube extends straight down the center of the receptacle, wherein the end of the suction tube is positioned in the middle of the bottom of the receptacle. Alternatively, the suction pump may be longer than the receptacle, such that the lower portion of the suction tube reaches the bottom of the receptacle, bends sideways and continues toward the junction where the bottom of the receptacle and the wall of the receptacle meet. In other designs, the pump may be positioned on the side of the top of the receptacle, near a wall of the receptacle, such that the suction tube may extend straight down the wall, ending at the junction where the bottom of the receptacle and the wall of the receptacle meet.

Other designs are, of course, conceivable, however the common problem associated with the prior art spray bottle designs is the difficulty of reaching the liquid in the receptacle once most of the liquid has been removed from the receptacle, and only a small amount of liquid remains. In such a situation, when the bottle is placed in an upright position on a flat surface, the end of the suction tube will either not be long enough to reach the remaining liquid, or the liquid may be pooled on one side of the bottom of the bottle and the end of the suction tube is positioned on another side of the bottom of the bottle. In both cases, the liquid is unable to be drawn up the suction tube from that position, and nothing will spray out of the nozzle.

The customary solution to this problem is to lift the bottle and tilt it at an angle at which the end of the suction tube will be situated in the remaining pool of liquid. Once the correct angular position is discovered, the bottle is then moved to the desired location and sprayed at the desired target.

However, the frustration of having to find the precise angle that would enable the pump to spray the liquid often results in the user discarding the bottle with the unused remaining liquid still in the receptacle.

When dealing with costly fluids such as perfumes, it is often not desirable to discard even small amounts. This leaves the user with no choice but to turn and rotate the bottle in order to establish the proper spraying angle as described above.

Perfumes are sprayed on different areas of the skin to allow the pleasant scent to diffuse around the person. It would be advantageous to enhance the perfume with supplementary components that would bring additional benefits to the person.

To that end, it is known that gemstones are comprised of minerals that crystalized due to high temperatures and pressures within the earth. These gemstones emit the energy stored within them, and it is believed that they thereby contribute healing properties to a person in their vicinity. The energy can restore and rebalance the minerals in the human body. The diverse minerals contained within each stone, as well as the distinctive colors of the various stones are believed to positively influence the health of different parts of the body as well as emotional and psychological needs of a person.

By submerging a gemstone within the perfume the liquid absorbs the emitted electrons. Thus, it is believed that when sprayed, the effects of the gemstone transfer to the person via the perfume.

Accordingly, it is a principal object of the present invention to provide a perfume bottle which overcomes the difficulties and drawbacks associated with the prior art as described in part herein above.

It is another object of the present invention to provide a perfume bottle that enables the user to deplete essentially all of the liquid accommodated within the receptacle without requiring the user to change the position of the bottle to be able to spray the liquid.

It is a further object of the present invention to provide a perfume bottle that may be kept in an upright position in order to spray the perfume regardless of how much liquid is in the receptacle.

It is yet another object of the present invention to provide a perfume bottle that requires little or no skill to operate.

It is yet a further object of the present invention to provide a perfume bottle that enables the liquid contained therein to absorb gemstone properties and to impart the same to the person on which it is sprayed.

Additional objects and advantages of the invention will become apparent as the description proceeds.

### SUMMARY OF THE INVENTION

In accordance with a preferred embodiment of the present invention, a perfume spray bottle is disclosed, comprising a receptacle having side walls and an inner bottom surface for accommodating liquids, wherein a minor portion of the bottom surface comprises a lower gathering region. The bottle further comprises a pump for drawing the liquid up a suction tube and through a nozzle. At least the end of the suction tube is disposed within the lower gathering region.

Optionally, the receptacle comprises two distinct sections separated by a divider extending from the top of the receptacle to the bottom, wherein each section comprises a lower gathering region and a pump for drawing the liquid up a suction tube and through a nozzle, and wherein at least the end of each of the suction tubes is disposed within one of each of the lower gathering regions.

Preferably, the suction tube is integrally formed within the wall of the receptacle.

At least one gemstone is preferably suspended within the receptacle, in proximity to the lower gathering region of the receptacle. When there are two sections within the receptacle, one gemstone is preferably suspended within each of the sections.

The at least one gemstone is removably replaceable within the receptacle, and connected to the top of the receptacle by hanging means

According to a preferred embodiment, the inner bottom surface is sloped toward the lower gathering region.

### BRIEF DESCRIPTION OF THE FIGURES

To accomplish the above and related objects, the invention may be embodied in the form illustrated in the accompanying drawings, attention being called to the fact, however, that the drawings are illustrative only, and that changes may be made in the specific construction illustrated and described.

FIG. 1 shows a front elevation view of a wireframe drawing of a first preferred embodiment of the present invention;

FIG. 2 shows a side elevation view of a wireframe drawing of a first preferred embodiment of the present invention;

FIG. 3 shows a front elevation view of a wireframe drawing of a second preferred embodiment of the present invention; and,

FIG. 4 shows a side elevation view of a wireframe drawing of a second preferred embodiment of the present invention.

### DETAILED DESCRIPTION OF THE PREFERRED EMBODIMENTS

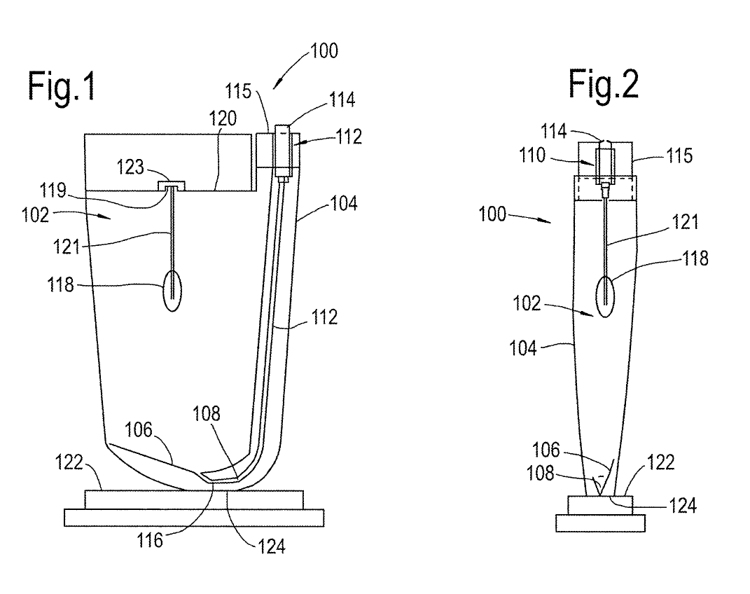

A wireframe drawing of a first preferred embodiment of the perfume bottle of the present invention is shown in a front elevation view in FIG. 1 and in a side elevation view in FIG. 2, generally designated by numeral (100). With reference to FIGS. 1 and 2, bottle (100) comprises a receptacle (102) having side walls (104) and an inner bottom surface (106) for accommodating liquids therein. A minor portion of bottom surface (106) comprises a lower gathering region (108) within which the liquid contained at inner bottom surface (106) collects. Inner bottom surface (106) is preferably sloped toward lower gathering region (108) to direct the liquid thereto. A pump (110) comprises a suction tube (112) for drawing up the liquid from bottom surface (106) of receptacle (102), and for spraying the liquid through an atomizer nozzle (114).

In this embodiment, suction tube (112) is integrally formed within a side wall (104) of receptacle (102), and the end (116) of suction tube (112) is integral with and disposed within lower gathering region (108) of bottom surface (106).

Alternatively the suction tube may be separate from the walls of the receptacle (not shown), wherein the suction tube runs down alongside the inner surface of a side wall of the receptacle and the end of the suction tube is disposed within the lower gathering region.

In the first preferred embodiment, a gemstone (118), such as quartz, is suspended within receptacle (102). As described above, gemstone (118) is believed to emit positive energy that provides a healing effect on the body. When submerged within the liquid in receptacle (102), the energy is believed to be absorbed in the liquid and transferred to the body when sprayed on the skin.

Although gemstone (118) is shown in the figures situated approximately halfway down toward bottom surface (106), preferably, gemstone (118) is suspended at least most of the way down toward bottom surface (106), in proximity to lower gathering region (108). This way, even when a small amount of liquid remains within receptacle (102), gemstone (118) may remain submerged within the liquid.

Gemstone (118) is connected to a stopper (123) that plugs up an opening (119) in the cover (120) of receptacle (102). Hanging means (121), such as a cord, a chain or any other suitable hanging means is attached at one end to stopper (123) and at the other end to gemstone (118). When stopper (123) is removed from opening (119) of receptacle (102) the gemstone (118) may be removed and replaced with the same or different gemstone (118).

A nozzle cover (115) is shown in the figures for protecting nozzle (114) from being damaged by external debris, as well as for preventing inadvertent spraying of the perfume.

In the embodiment shown in the figures, perfume bottle (100) is mounted on a base (122). Base (122) may be integrally attached to receptacle (102) or base (122) may comprise an impressed portion in which receptacle (102) may sit. Alternatively, at least a portion of outer bottom surface (124) of receptacle (102) may be flat for placing directly on a level surface without base (122).

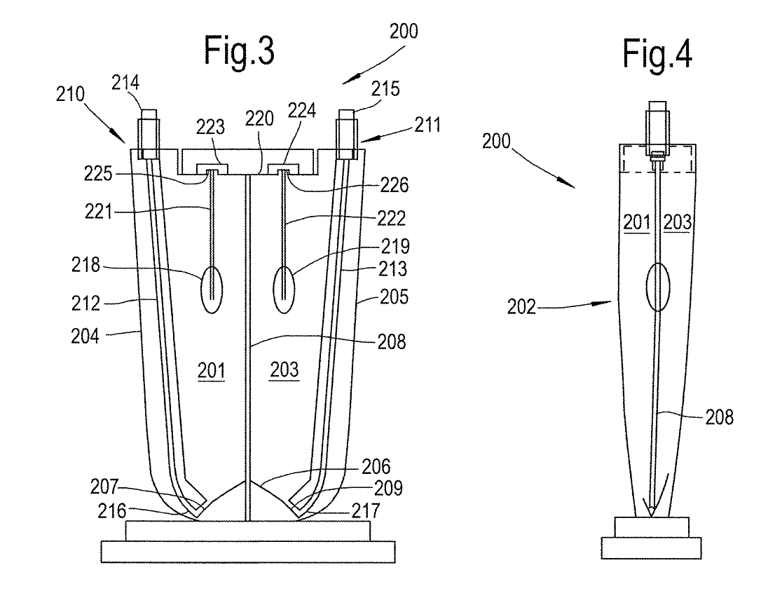

With reference to FIGS. 3 and 4, a wireframe drawing of a second preferred embodiment of the perfume bottle of the present invention is shown a front elevation view (FIG. 3) and a side elevation view (FIG. 4), generally designated by numeral (200). Perfume bottle (200) comprises all of the same features of the first embodiment with the following differences, mutatis mutandis. Receptacle (202) comprises two distinct sections (201), (203) separated by a divider (208) extending from the top (220) of receptacle (202) to the inner bottom surface (206). Each section (201), (203) comprises a lower gathering region (207), (209) respectively, and a pump (210), (211) for drawing liquid up a suction tube (212), (213) and through a nozzle (214), (215). Inner bottom surface (206) is sloped toward lower gathering region (207), (209) respectively to direct the liquid thereto. Suction tubes (212), (213) may be integrally formed within a side walls (204), (205) or may be independent from side walls (204), (205), as described above regarding the first embodiment, wherein the end (216), (217) of suction tube (212), (213) is disposed within lower gathering region (207), (209) respectively.

A gemstone (218), (219) believed to have a healing effect on the body as described above, is suspended within each section (201), (203) from the cover (220), connected thereto by hanging means (221), (222). Gemstones (218), (219) are connected to stoppers (223), (224) that plug up openings (225), (226) in the cover (220) of receptacle (202) by hanging means (221), (222), such as a cord, a chain or any other suitable hanging means which is attached at one end to a stopper (223), (224) and at the other end to a gemstone (218), (219) respectively. Preferably, gemstones (218), (219) are suspended in proximity to lower gathering region (207), (209).

It is understood that the above description of the embodiments of the present invention are for illustrative purposes only, and is not meant to be exhaustive or to limit the invention to the precise form or forms disclosed, as many modifications and variations are possible. Such modifications and variations are intended to be included within the scope of the present invention as defined by the accompanying claims.

1. A perfume spray bottle comprising a receptacle having side walls and an inner bottom surface for accommodating liquids, wherein a minor portion of said bottom surface comprises a lower gathering region, said bottle further comprising a pump for drawing said liquid up a suction tube and through a nozzle, wherein at least the end of said suction tube is disposed within said lower gathering region.

2. A perfume bottle according to claim 1, wherein the receptacle comprises two distinct sections separated by a divider extending from the top of said receptacle to the bottom, wherein each section comprises a lower gathering region and a pump for drawing said liquid up a suction tube and through a nozzle, and wherein at least the end of each of said suction tubes is disposed within one of each of said lower gathering regions.

3. A perfume bottle according to claim 1, wherein the suction tube is integrally formed within the wall of the receptacle.

4. A perfume bottle according to claim 1, wherein at least one gemstone is suspended within the receptacle.

5. A perfume bottle according to claim 2, wherein one gemstone is suspended within each of the sections of the receptacle.

6. A perfume bottle according to claim 4, wherein the at least one gemstone is suspended in proximity to the lower gathering region of the receptacle.

7. A perfume bottle according to claim 4, wherein the at least one gemstone is removably replaceable within the receptacle.

8. A perfume bottle according to claim 4, wherein the at least one gemstone is connected to the top of the receptacle by a hanging means.

9. A perfume bottle according to claim 1, wherein the inner bottom surface is sloped toward the lower gathering region.

10. A perfume bottle according to claim 2, wherein the suction tube is integrally formed within the wall of the receptacle.
